(19) United States
(12) Patent Application Publication
(10) Pub. No.: US 2025/0149230 A1
(43) Pub. Date: May 8, 2025

(54) LOW LOSS WINDING PLANAR TRANSFORMERS FOR MULTI- OUTPUT FLYBACK CONVERTERS

(71) Applicant: Navitas Semiconductor Limited, Dublin (IE)

(72) Inventors: Xiucheng Huang, Torrance, CA (US); Teng Tian, Shenzhen (CN); Weijing Du, Torrance, CA (US)

(73) Assignee: Navitas Semiconductor Limited, Dublin (IE)

(21) Appl. No.: 18/438,140

(22) Filed: Feb. 9, 2024

(30) Foreign Application Priority Data
Nov. 7, 2023 (CN) 202311483644.6

(51) Int. Cl. H01F 27/28; H01F 27/24; H01F 41/02; H01F 41/04

(52) U.S. Cl. CPC H01F 27/28; H01F 27/24; H01F 41/0206; H01F 41/04

(57) ABSTRACT

A transformer is disclosed. The transformer includes a magnetic core having a central region, a primary winding extending around the central region, a first secondary winding including a first conductor having one or more first turns extending around the central region, where the first conductor has a first width and is arranged to receive electromagnetic flux from the primary winding, and a second secondary winding including a second conductor having one or more second turns extending around the central region, where the second conductor has a second width and is arranged to receive electromagnetic flux from the primary winding. In one aspect, a number of the one or more second turns is greater than a number of the one or more first turns and the first width is greater than the second width.

### CROSS REFERENCE TO RELATED APPLICATIONS

This application claims priority to Chinese provisional patent application no. 202311483644.6, for “LOW LOSS WINDING PLANAR TRANSFORMERS FOR MULTI-OUTPUT FLYBACK CONVERTERS” filed on Nov. 7, 2023, which is hereby incorporated by reference in entirety for all purposes.

### FIELD

The described embodiments relate generally to power converters, and more particularly, the present embodiments relate to low loss winding planar transformers for multi-output flyback power converters.

### BACKGROUND

Electronic devices such as computers, servers and televisions, among others, employ one or more electrical power conversion circuits to convert one form of electrical energy to another. Some electrical power conversion circuits convert a high (or low) DC voltage to a lower (or higher) DC voltage using a circuit topology called DC-DC converter. As many electronic devices are sensitive to size and efficiency of the power conversion circuit, new power converters can provide relatively higher efficiency and lower size for the new electronic devices.

### SUMMARY

In some embodiments, a transformer is disclosed. The transformer includes a magnetic core having a central region; a primary winding extending around the central region; a first secondary winding including a first conductor having one or more first turns extending around the central region, where the first conductor has a first width and is arranged to receive electromagnetic flux from the primary winding; and a second secondary winding including a second conductor having one or more second turns extending around the central region, where the second conductor has a second width and is arranged to receive electromagnetic flux from the primary winding, wherein a number of the one or more second turns is greater than a number of the one or more first turns and the first width is greater than the second width.

In some embodiments, the magnetic core defines a winding region that is concentric with the central region and has a predefined width to receive the first and second secondary windings.

In some embodiments, the predefined width is greater than the second width of the second conductor.

In some embodiments, the second width is greater than 50% of the predefined width.

In some embodiments, the second width is greater than 75% of the predefined width.

In some embodiments, the second width is greater than 90% of the predefined width.

In some embodiments, the first secondary winding is on a first layer and the second secondary winding is on a second layer.

In some embodiments, the first secondary and at least a portion of the second secondary winding are on a same layer.

In some embodiments, an inductor is disclosed. The inductor includes a magnetic core having a central region, and a conductor having a first winding extending around the central region and a second winding extending around the central region, wherein a first width of the conductor in the first winding is greater than a second width of the conductor in the second winding.

In some embodiments of the inductor, the magnetic core has a predefined width to receive the first and second windings.

In some embodiments of the inductor, the first winding is an exterior winding and the second winding is an interion winding.

In some embodiments of the inductor, the conductor further comprises a third winding extending around the central region and having the first width.

In some embodiments of the inductor, the second winding is position between the first and third winding.

In some embodiments of the inductor, the magnetic core defines a winding region that is concentric with the central region and has a predefined width to receive the first and second windings.

In some embodiments of the inductor, the first width is at least 75% of the predefined width.

In some embodiments of the inductor, the first width is at least 90% of the predefined width.

In some embodiments, a method of forming a transformer is disclosed. The method includes providing a magnetic core having a central region; forming a primary winding extending around the central region; forming a first secondary winding including a first conductor having one or more first turns extending around the central region, where the first conductor has a first width and is arranged to receive electromagnetic flux from the primary winding; and forming a second secondary winding including a second conductor having one or more second turns extending around the central region, wherein the second conductor has a second width and is arranged to receive electromagnetic flux from the primary winding, wherein a number of the one or more second turns is greater than a number of the one or more first turns and the first width is greater than the second width.

### BRIEF DESCRIPTION OF THE DRAWINGS

FIG. 1 illustrates a dual-output quasi-resonant (QR) flyback converter using a low loss winding planar transformer, according to some embodiments of the disclosure;

FIG. 2A illustrates a cross-sectional view of a low winding loss planar transformer with multiple outputs with a complete layer at the top, according to some embodiments of the disclosure;

FIG. 2B illustrates a cross-sectional view of a low winding loss planar transformer with multiple outputs with a complete layer at the bottom, according to certain embodiments of the disclosure;

FIG. 2C illustrates a low winding loss planar transformer with a top complete layer, according to some embodiments;

FIG. 2D illustrates a low winding loss planar transformer with a bottom complete layer, according to some embodiments;

FIG. 2E illustrates a of a low winding loss planar transformer with both top and bottom complete layers, according to some embodiments;

FIG. 2F shows a planar transformer structure that can further include structures with low permeability materials, according to some embodiments;

FIG. 2G shows a planar transformer structure that can include structures with distributed gaps in the magnetic core, according to some embodiments;

FIG. 2H shows a planar transformer structure, according to some embodiments;

FIG. 3 shows graphs illustrating orthogonal decomposition of currents flowing in a transformer used in a flyback power converter operating in discontinuous conduction mode, according to some embodiments;

FIG. 4 shows graphs illustrating relationship between total winding loss as a function of load variation of the disclosed planar transformer of FIG. 2A;

FIG. 5 shows graphs illustrating relationship between total winding loss as a function of operating frequency of the disclosed planar transformer of FIG. 2A;

FIG. 6 illustrates eddy currents induced in a conductor by an alternating magnetic field;

FIG. 7 illustrates magnetic field distribution of the planar transformer of FIG. 2A using finite element method (FEM), according to some embodiments;

FIG. 8 illustrates schematic diagram of an equivalent magnetic circuit for a distributed air gap magnetic core structure, according to some embodiments;

FIG. 9 illustrates the variation curve of MMF along the directions of the dashed lines A1, B1, B2, and A2 within the core in FIG. 8;

FIG. 10 illustrates the variation of the magnetic field distribution of the planar transformer of FIG. 2A, according to some embodiments;

FIG. 11 illustrates time-domain distribution of the winding losses for various planar transformer structures using FEM, according to some embodiments;

FIG. 12 shows a modification coupon having a prototype of a 78 W dual-output QR flyback converter for a television power supply;

FIGS. 13A-13D shows graphs of efficiency as a function of load for various embodiments of disclosed planar transformer with low winding loss at various input voltage levels;

FIGS. 14A-14D illustrates cross-sectional views of inductors having windings with varied width, according to some embodiments; and

FIG. 15 illustrates graphs showing winding losses for winding structures of FIGS. 14A-14D as a function of frequency.

### DETAILED DESCRIPTION OF THE INVENTION

Circuits, structures, and related techniques disclosed herein relate generally to power converters. More specifically, circuits, devices and related techniques disclosed herein relate to transformers used in flyback converters. Embodiment of the disclosure are related to structures and methods for optimizing winding losses in planar transformers used in multi-output flyback converters. Structures, devices and related techniques disclosed herein can enable a reduction of winding losses by forming a top and/or bottom of a secondary winding of the planar transformer that extends across an entire width of the winding area of the planar transformer to block magnetic stray flux, thereby improving efficiency of the power converter. Structures and techniques disclosed herein enable suppression of stray flux in the magnetic core window of multi-output flyback planar transformers, thus enabling a reduction of relatively high-frequency (AC) winding losses.

In some embodiments, the multi-output flyback power converter may be a dual-output flyback power converter. The dual-output power converter may have a transformer that can include a primary winding and a secondary winding, where the secondary winding can include a first secondary winding and a second secondary winding. In various embodiments, the second secondary winding may have more turns than the first secondary winding and the first secondary winding may have a greater width than the second secondary winding. In some embodiments, the first secondary winding may have a width that is greater than h width of transformer area such that it blocks stray magnetic flux. This may be counterintuitive as the winding with fewer turns would likely be made narrower than a winding with many turns to reduce DCR of winding with many turns, however structures and technique disclosed herein can substantially reduce AC losses thereby reducing the overall losses.

In some embodiments, an inductor may have windings with varied width where external windings extend across a substantial portion of the inductor area in order to block stray flux. In various embodiments, the multi-output power converter may use gallium nitride (GaN) and/or silicon carbide (SiC) based switches, such that the power converter may operate at relatively high operational frequencies as compared to power converters using silicon-based switches. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

In current approaches, a multi-output flyback converter (MOFC) may use closed-loop feedback control only for the main output, while the auxiliary outputs may lack feedback regulation. Due to component non-idealities, such as voltage drop across secondary diodes and variations in transformer winding resistance and leakage inductance, the MOFC may exhibit cross-regulation operation. In current approaches, power conversion circuits may use planar transformers that have a compact structure that can result in reduced spacing between windings, and between windings and the magnetic core. This reduction in spacing may deteriorate skin effect and proximity effect, resulting in increased winding losses. In current approaches, planar transformers used in flyback converters may utilize ferrite materials as the core. The intensity of this diffusion flux may increase as the distance from the gap decreases. Additionally, there may be substantial magnetic potential difference between the upper and lower magnetic yokes of the core, resulting in the creation of stray flux within the core window. These leakage fluxes may pass through the windings, leading to increased winding losses.

Embodiments of the disclosure can suppress stray flux in MOFC planar transformers. In some embodiments, an air gap may be formed in the core that can concentrate the magnetic potential at the gap ends, thereby generating diffusion flux within the core window. Techniques disclosed herein provide methods for analysis of the losses associated with windings in MOFC planar transformers, along with methods of planar transformer winding formation and optimization.

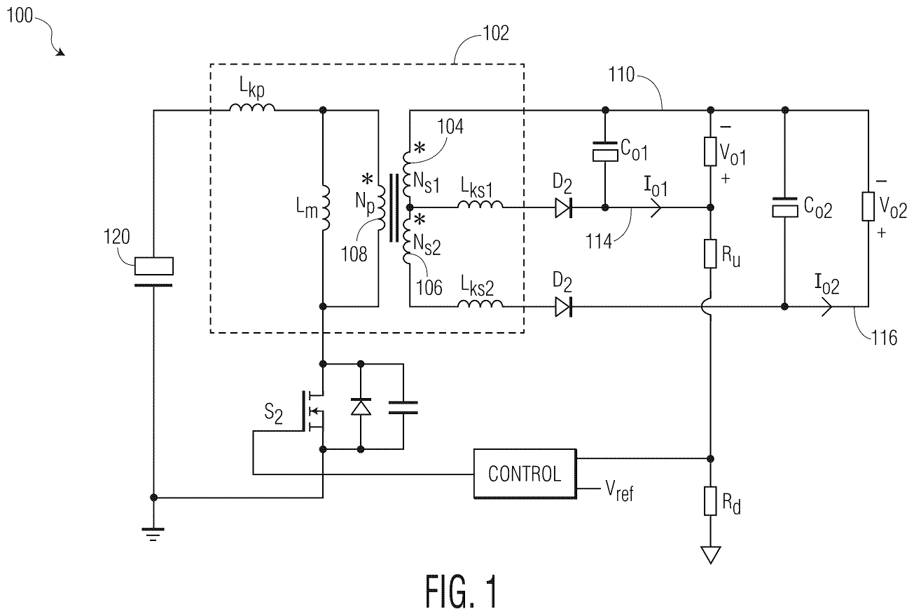

FIG. 1 illustrates a dual-output quasi-resonant (QR) flyback converter using a low loss winding planar transformer, according to some embodiments of the disclosure. In the illustrated embodiment, the QR flyback converter 100 may include a first output terminal 110, a second output terminal 114 and a third output terminal 116. The QR flyback converter 100 can generate a first output voltage Vo1 between the first and second output terminals 110 and 114 and a first output current Io1. Further, the QR flyback converter 100 can generate a second output voltage Vo2 between the first and third output terminals 110 and 116, respectively, and a second output current Io2. In some embodiments, for example, Vo1=12V and Vo2=120V, while Io1=2.5A and Io2=0.4A. Other suitable voltages for the first and second output voltages may be used, and other suitable first and second load currents may be used. The QR flyback converter 100 may be coupled to an input supply 120. The input supply 120 may have a value, for example, 90V to 264V, however other suitable voltage values may be used. The QR flyback converter 100 may be include a transformer 102. The transformer 102 may have a primary winding 108, a first secondary wining 104 and a second secondary winding 106. The primary winding 108 may have, for example, a number turns Np=14, the first secondary winding may have number of turns, for example, Ns1=1 and the second secondary winding may have a number turns, for example, Ns2=9. The first and second output voltages Vo1 and Vo2 may be connected through a shared winding that can result in an actual turns ratio of 14:1:10.

In the illustrated embodiment, the windings can be formed using a 6-layer printed circuit board (PCB) and the secondary winding may be arranged on the top and bottom layers. Other number of PCB layers may be used. In current approaches the winding DC losses may be minimized, thus a cross-sectional area (S) of the secondary winding may satisfy equation (1):

$$\frac{{I}_{o 1} + {I}_{o 2}}{{S}_{ws 1}} = \frac{{I}_{o 2}}{{S}_{ws 2}} = … = \frac{{I}_{o 2}}{{S}_{ws 10}} \qquad ( 1 )$$

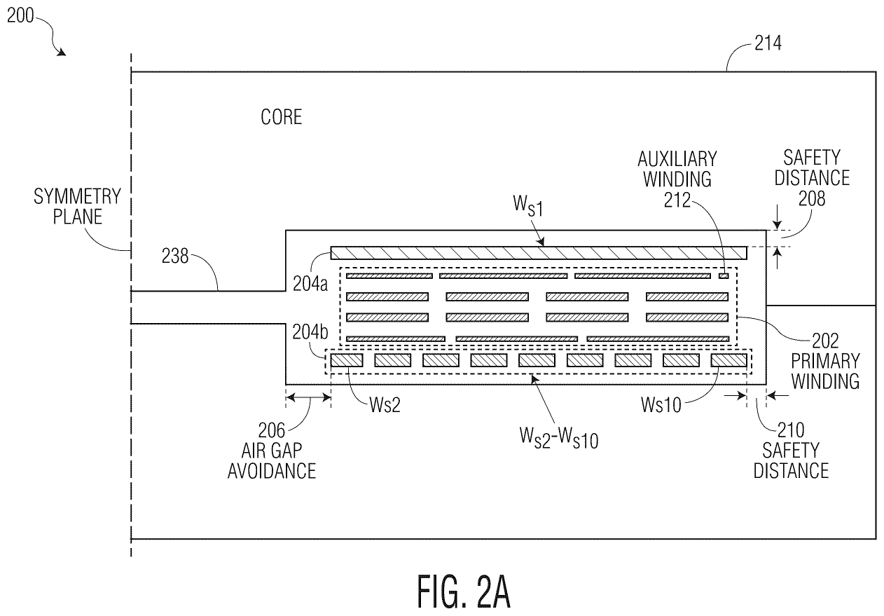

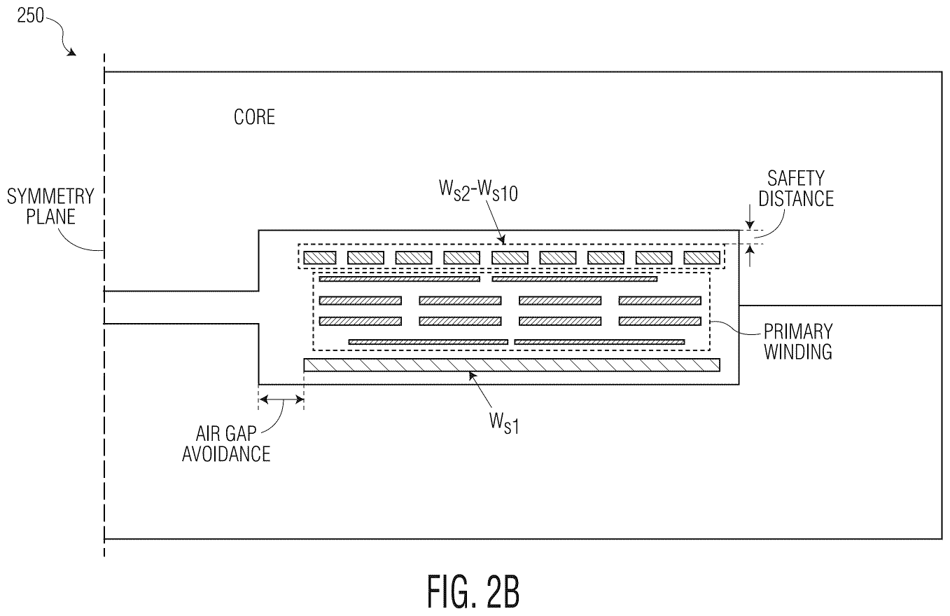

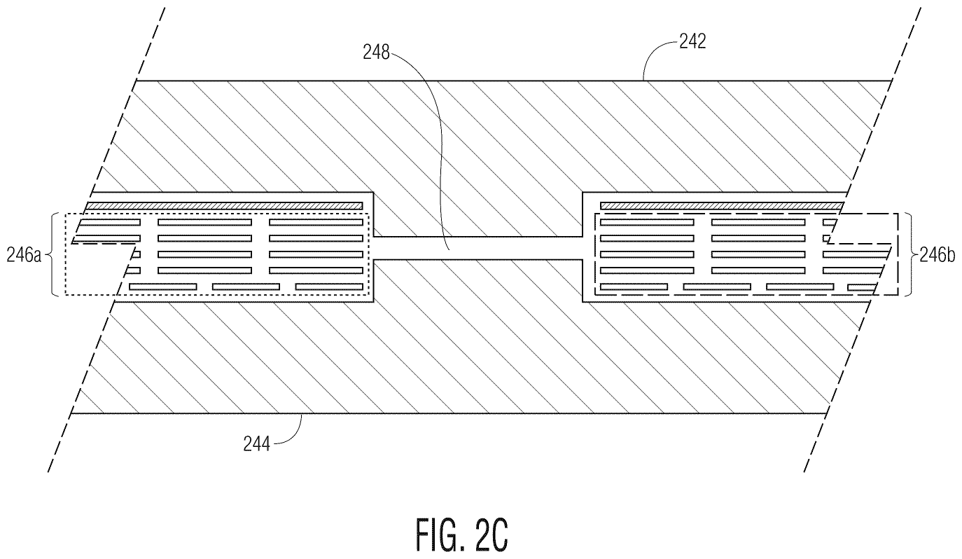

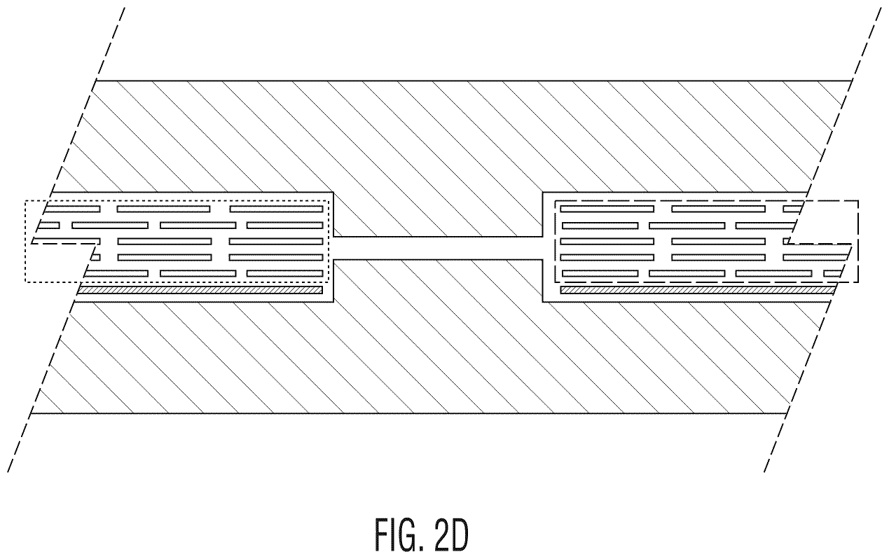

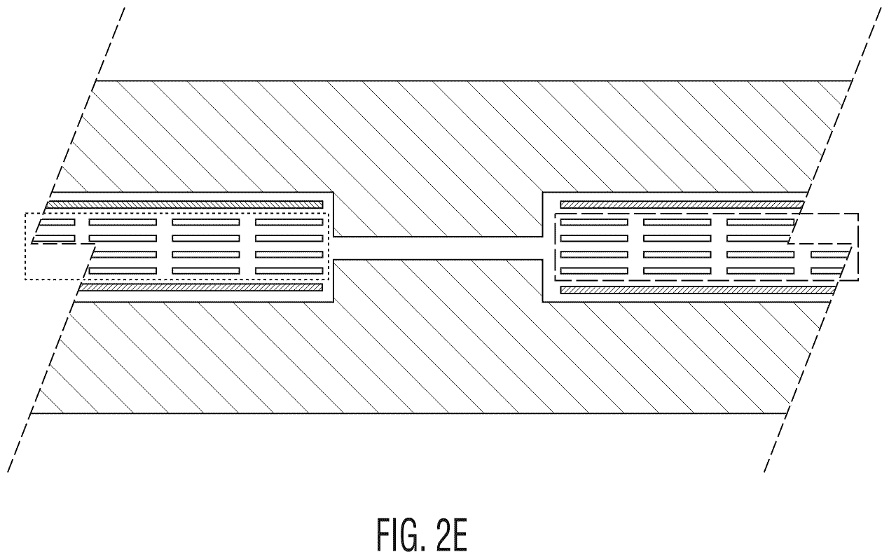

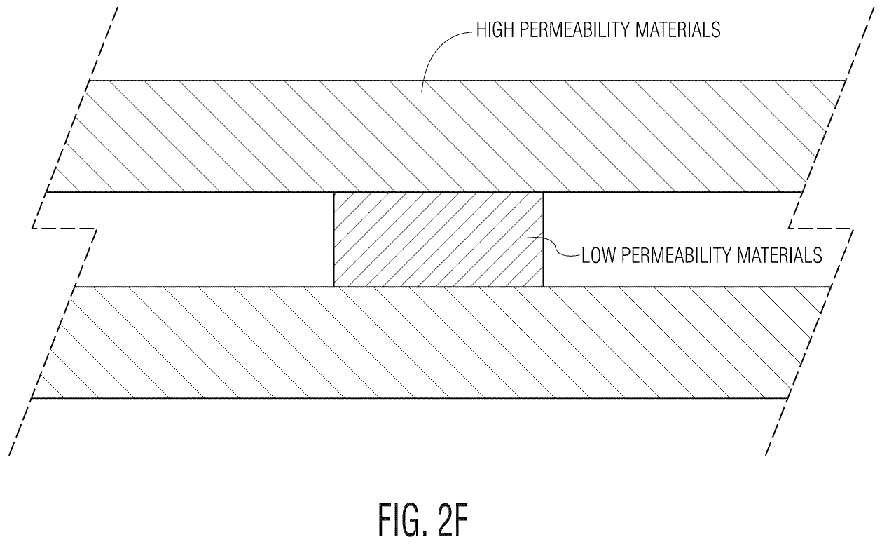

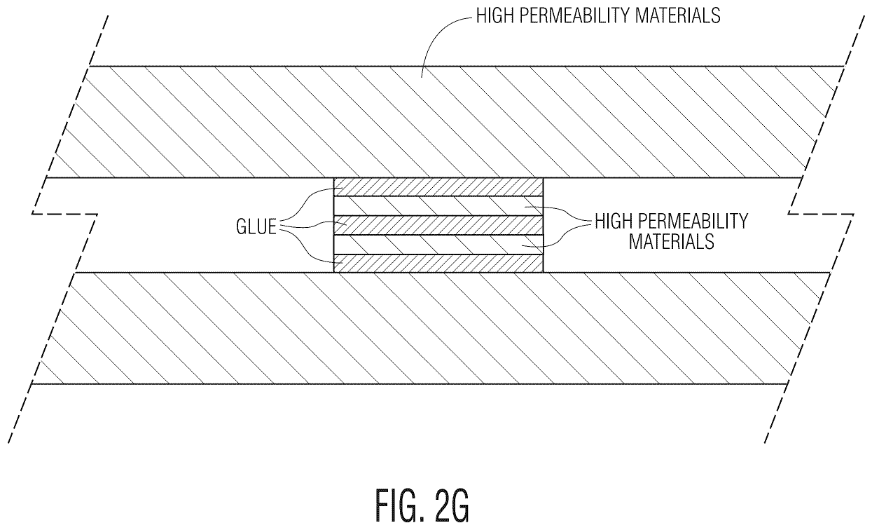

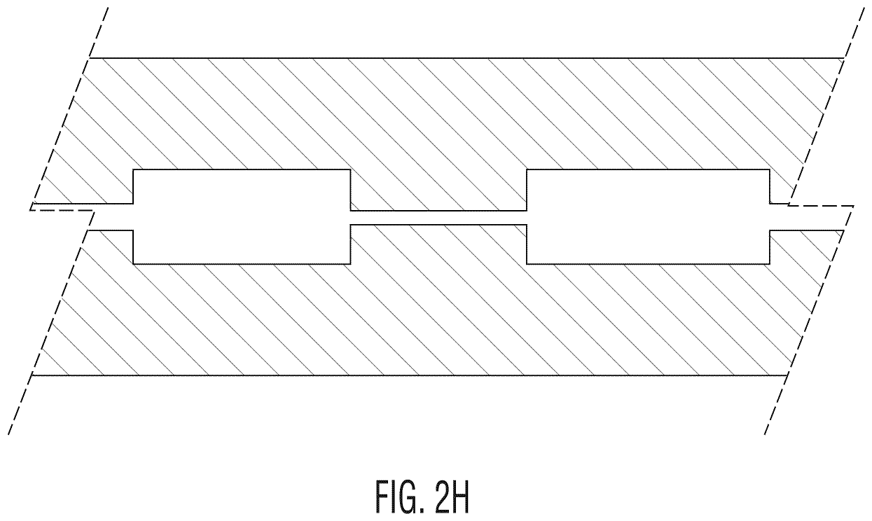

FIG. 2A illustrates a cross-sectional view of a low winding loss planar transformer with multiple outputs that may be used in the QR flyback converter 100, according to some embodiments of the disclosure. As shown in FIG. 2A, a planar transformer 200 can include a magnetic core 214, an airgap 238, a primary winding 202, a first secondary winding 204a and a second secondary windings 204b, and an auxiliary wining 212. The planar transformer 200 can further include an air gap avoidance 206, a first safety distance 208 and a second safety distance 210. The air gap avoidance 206 can be a clearance distance between the second secondary windings 204b and the core 214 at a proximal location. The second safety distance 210 can be a distance between the second secondary winding 204b and the core 214 at a distal location. The first safety distance 208 can be a distance between the first secondary winding 204a and the core 214. In the illustrated embodiment, the planar transformer 200 can include a 6-layer printed circuit board (PCB) winding with the secondary winding arranged on the top and bottom layers. The core of the transformer may also be referred to as magnetic core.

The primary winding 202 can include, for example, 14 turns, however other suitable number of primary windings can be used. The first secondary windings 204a (ws₁) may include, for example, 1 turn that may be shared between the first output voltage Vo₁ and the second output voltage Vo₂, and the second secondary windings 204b can include, for example, 9 turns (ws₂ to ws₁₀). Other suitable number of turns may be used for the first and second secondary windings. In various embodiments, the second secondary winding may have more turns than the first secondary winding and the first secondary winding may have a greater width than the second secondary winding. Winding ws₂ can be disposed away from the core 214 by the air gap avoidance 206, and winding ws₁₀ can be disposed away from the core 214 by the second safety distance 210. In the illustrated embodiment, while ensuring compliance with national safety regulations, the windings can be disposed relatively close to the magnetic core to utilize the magnetic core window volume. Sufficient clearance can be provided on the side near the air gap. In the illustrated embodiment, the transformer 102 can include a first secondary winding 104a (ws1) that is disposed in an uppermost layer of the winding, while the second secondary winding 104b (ws2 to ws10) may be uniformly distributed in the lowermost layer.

FIG. 2B illustrates a cross-sectional view of a low winding loss planar transformer with multiple outputs that may be used in the QR flyback converter 100, according to certain embodiments of the disclosure. FIG. 2B shows a planar transformer 250 that is similar to the planar transformer 200, except that ws1 having a complete layer is disposed at the bottom and ws2-ws10 are disposed at the top of the transformer.

FIG. 2C illustrates a low winding loss planar transformer with a top complete layer, according to some embodiments. The illustrated planar transformer may include a first and second core 242 and 244, respectively. The illustrated planar transformer may also include windings sections 246a and 246b, where the top layer of the windings is a complete conductor. The illustrated planar transformer can have a window with an air gap 248. While the illustrated embodiment shows a single air-gap core structure, the winding structures and techniques disclosed herein can be used in all magnetic core transformer structures.

FIG. 2D illustrates a low winding loss planar transformer with a bottom complete layer, according to some embodiments. The illustrated planar transformer shown in FIG. 2D is similar to the planar transformer shown in FIG. 2C, except that the bottom layer in the windings is a complete layer.

FIG. 2E illustrates a of a low winding loss planar transformer with both top and bottom complete layers, according to some embodiments. The illustrated planar transformer shown in FIG. 2E is similar to the planar transformer shown in FIG. 2C, except that both top and bottom layers in the windings are a complete layer. Planar transformer structures disclosed herein can include structures with a single gap in the magnetic core. Planar transformer structures disclosed herein can further include structures with low permeability materials, as shown in FIG. 2F. Moreover, planar transformer structures disclosed herein can include structures with distributed gaps in the magnetic core, as shown in FIG. 2G-2H.

Techniques disclosed herein enable design and formation of the planar transformer 200 with reduce winding losses. When a conductor is subjected to an alternating magnetic field, the magnetic field can induce an eddy current in the conductor that may result in the generation of a magnetic field that opposes an external magnetic field, thereby impeding a flow of eddy current in the conductor. This generated magnetic field can be determined by the conductor's conductivity and the frequency of the alternating magnetic field. Thus, placement of a copper on the winding's surface can impede the magnetic flux through the winding. Techniques disclosed herein can be used to form low winding loss transformers for any core shapes such as, but not limited to, EIR, EI, U, or C-shaped cores, and to any number of winding layers in the planar transformer.

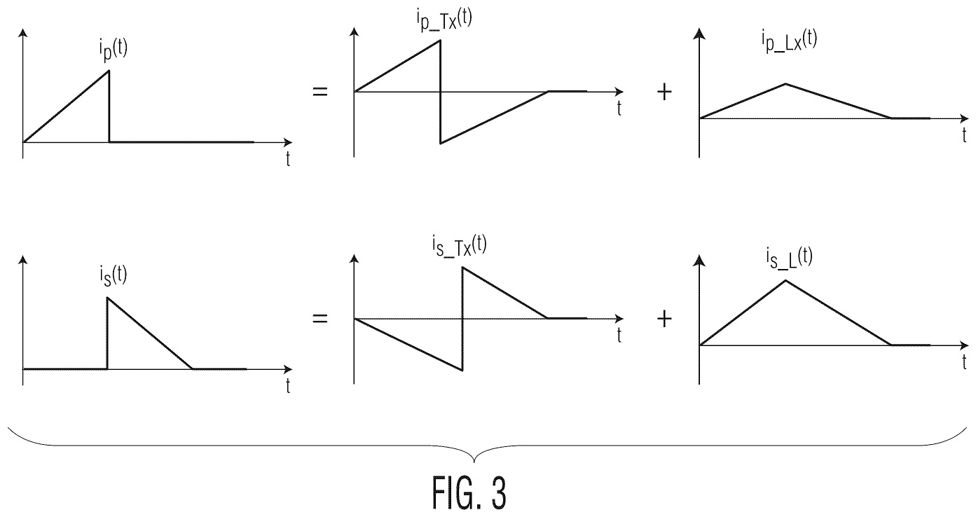

FIG. 3 shows graphs illustrating orthogonal decomposition of currents flowing in a transformer used in a flyback power converter operating in discontinuous conduction mode (DCM), according to some embodiments. A current flowing through a primary winding and a secondary winding of a single-output flyback converter operating in DCM, can be mathematically separated into two orthogonal current components. Specifically, ip_L(t) and ip_TX(t) that are orthogonal and is_L(t) and is_TX(t). ip_L(t) and is_L(t) that are referred to as the inductor component because of their phase relationship being the same as the inductor current. Similarly, ip_TX(t) and is_TX(t) may have the same phase relationship as the transformer current, hence they are referred to as the transformer component. The sum of the winding losses generated by these two components equals the total winding losses. By applying frequency domain analysis method for high-frequency winding losses, the periodic current i(t) can be decomposed using Fourier decomposition as follows:

$$i ( t ) = {I}_{dc} + {\sum }_{n = 1}^{∞} {I}_{ac\_n} cos ( n ω t + {θ}_{n} )$$

Idc refers to the direct current (DC) component of i(t), while Iac_n represents the amplitude of the nth harmonic component of i(t). Under the excitation of i(t), the total winding loss is the sum of the losses caused by each individual harmonic component of i(t). This relationship can be expressed as:

$${P}_{WindingLoss\_Total} = {P}_{WindingLoss\_DC} + {\sum }_{n = 1}^{∞} {P}_{WindingLoss\_AC} ( n )$$

The variables P_{WindingLoss_Total}, P_{WindingLoss_DC}, and P_{WindingLoss_AC}(n) represent the total winding loss, the winding loss induced by the DC component of i(t), and the winding loss induced by the nth harmonic component of i(t), respectively. When analyzing the winding loss of a single-output flyback converter through frequency domain analysis, it is noted that the ip_L(t), is_L(t), and ip_TX(t), is_TX(t) may be orthogonal. Thus, the harmonic components derived from their Fourier decomposition are also orthogonal. The total winding loss is a summation of the individual winding losses caused by each harmonic component, and can be expressed as follows:

$${P}_{WindingLoss\_Total} = {P}_{L\_WindingLoss \_Total} + {P}_{Tx\_WindingLoss \_Total}$$

P_{L_WindingLoss_Total} and P_{Tx_WindingLoss_Total} represent the winding loss under the excitation of ip_L(t), is_L(t), and ip_TX(t), is_TX(t).

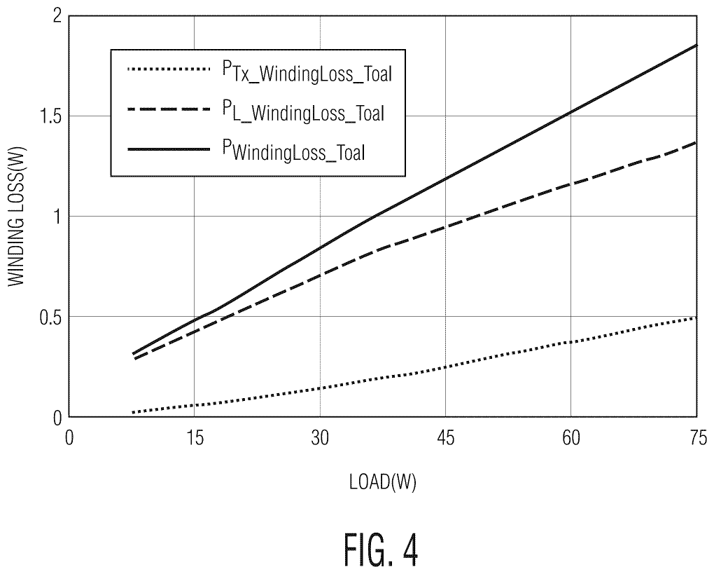

FIG. 4 shows graphs illustrating relationship between total winding loss as a function of load variation. In particular, FIG. 4 shows relationship between the total winding loss of an exemplary 78 W single-output flyback converter's planar transformer as a function of its load variation, that is operating in discontinuous condition mode (DCM). As can be seen in FIG. 4, as the load increases, P_{L_WindingLoss_Total} dominants.

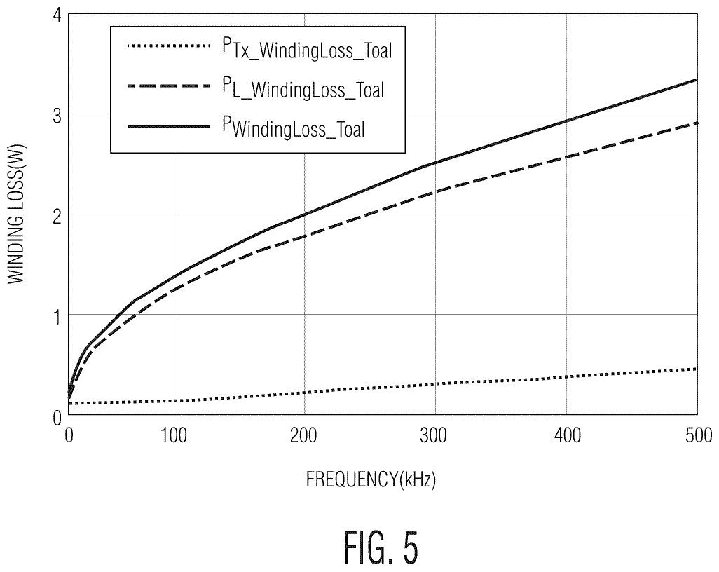

FIG. 5 shows graphs illustrating relationship between total winding loss as a function of operating frequency. The graphs in FIG. 5 are for an exemplary 78 W single-output flyback converter's planar transformer. As can be seen in FIG. 5, as the frequency increases, P_{L_WindingLoss_Total} dominates.

In the case of a quasi-resonant (QR) flyback converter operating in DCM, the main contributor to total winding losses is the eddy current losses generated by the inductor current. As such, optimizing the transformer winding design of a single-output QR flyback converter may focus on mitigating the winding eddy current losses.

For MOFC, although the current flowing through the primary winding of the transformer may be similar to that of a single-output configuration, the currents flowing through each secondary branch differ due to variations in turns ratio and output branch impedance. However, when converting the secondary currents of MOFC to the primary side, the summation of these currents equals that of a single-output flyback converter. In some embodiments, design and formation of transformer windings in multi-output QR flyback converters may deal with mitigating the winding eddy current losses induced by the inductive current components.

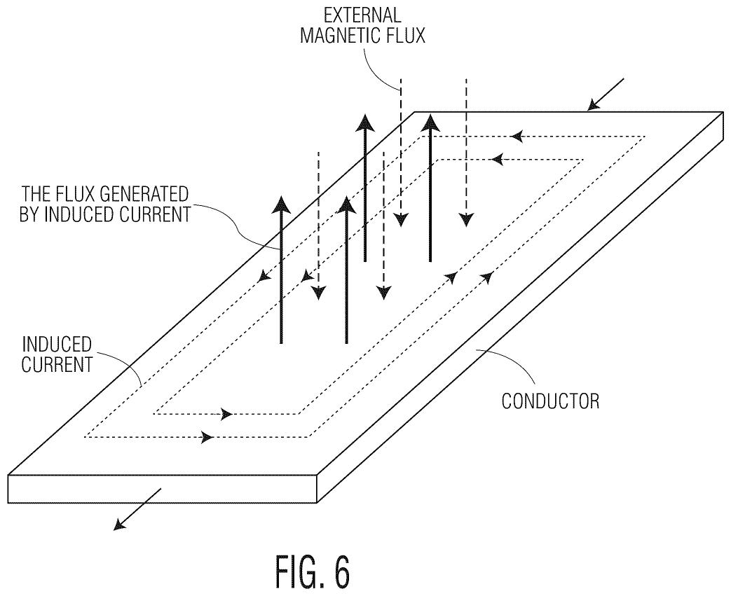

FIG. 6 illustrates eddy currents induced in a conductor by an alternating magnetic field. These eddy currents can result in generation of a magnetic field that can oppose the external magnetic field, thereby impeding the eddy current flow through the conductor. The magnitude filed generated by the eddy currents can be determined by the conductor's conductivity and the frequency of the alternating magnetic field. In some embodiments, the placement of a conductor, such as but not limited to copper, on the winding's surface can impede the magnetic flux through the winding.

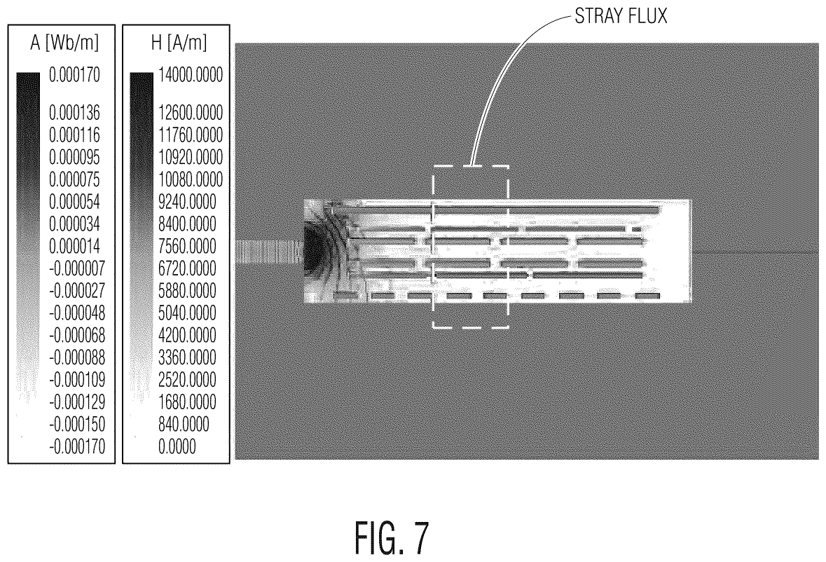

FIG. 7 illustrates magnetic field distribution of the planar transformer 200 using finite element method (FEM), according to some embodiments. As shown in FIG. 7, the stray flux crossing the winding can be substantially reduced.

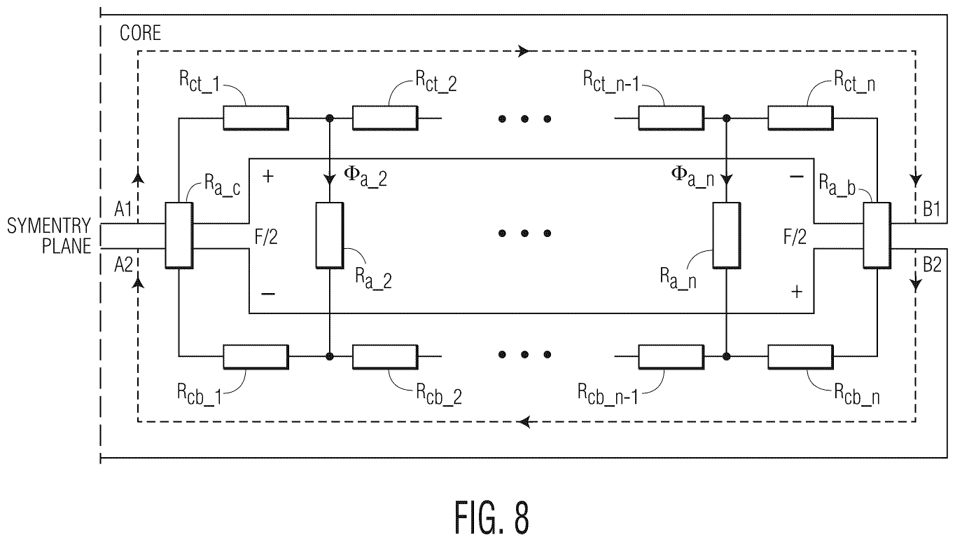

FIG. 8 illustrates schematic diagram of an equivalent magnetic circuit for a distributed air gap magnetic core structure, according to some embodiments. In the illustrated embodiment, the air gaps in the central column and the side columns can be made to be of equal size. As can be seen in FIG. 8, the concentrated magnetomotive force (MMF) in the air gap of the central column can be evenly distributed to both air gaps in the central and side columns. In various embodiments, the illustrates schematic diagram of FIG. 8 can represent planar transformer 200.

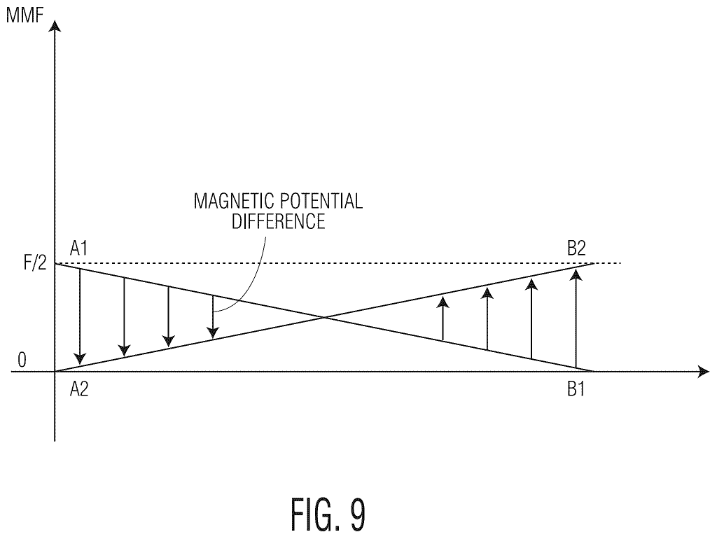

FIG. 9 illustrates the variation curve of MMF along the directions of the dashed lines A1, B1, B2, and A2 within the core in FIG. 8. In the illustrated embodiment, the distributed airgap can substantially reduce the difference in magnetic potential between the upper and lower backplates as compared to traditional core structures that use only the central core columns having an air gap. The stray flux in the core window (Φa_2˜Φa_n) represents the magnetic potential difference between the upper and lower backplates divided by the magnetic resistance in the core window (Ra_2˜Ra_n). As can be seen in FIG. 9, the stray flux can be substantially reduced for the planar transformer 200.

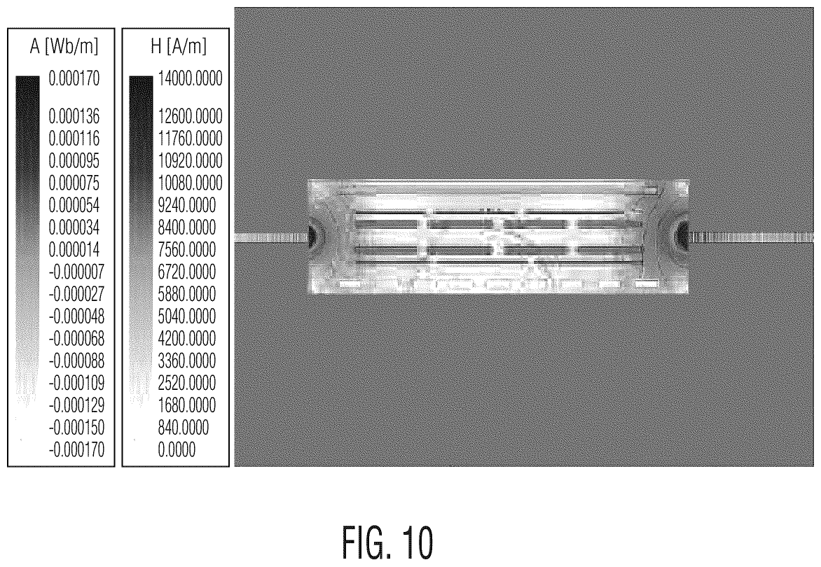

FIG. 10 illustrates the variation of the magnetic field distribution of the planar transformer 200, according to some embodiments. As shown in FIG. 10, the stray flux in the core window can be reduced by employing a distributed airgap structure. It can be further be seen that the improved winding structure of planar transformer 200 is effective when using a distributed airgap structure.

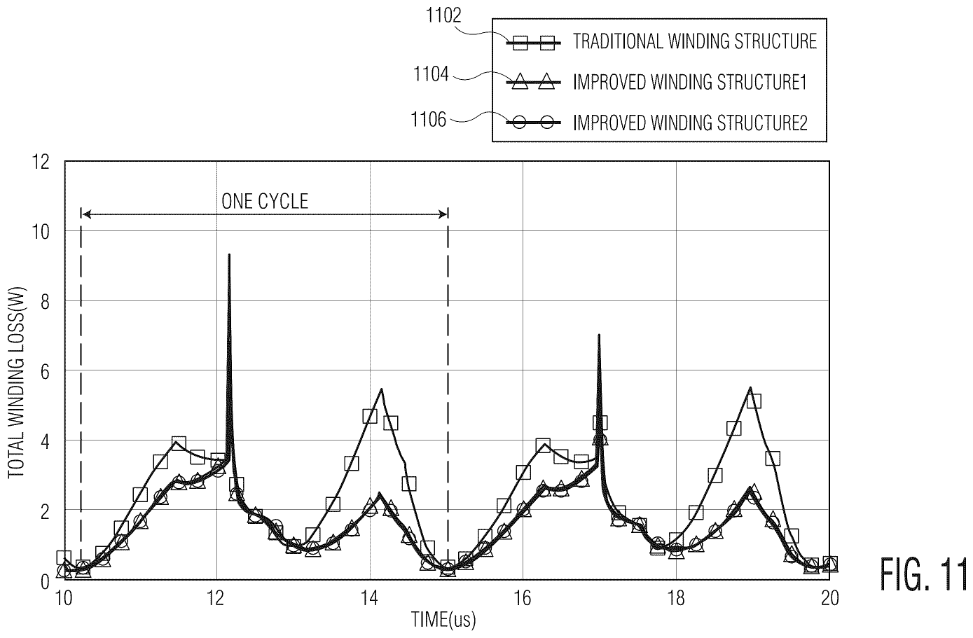

FIG. 11 illustrates time-domain distribution of the winding losses for various planar transformer structures using FEM, according to some embodiments. Graph 1102 illustrates time-domain distribution of the winding losses for current approaches, graph 1104 illustrates time-domain distribution of the winding losses for the discloses planar transformer 200 and graph 1106 illustrates time-domain distribution of the winding losses for the discloses planar transformer 250. Table 1 lists the average values of the winding losses for various structures, combinations. As shown in FIG. 11 and table 1, using current approaches for the core structure, the disclosed embodiments of winding structure can reduce the winding losses by 0.827 W as compared to the current approaches. This is substantial reduction in winding losses. Further, using the distributed air gap core structure, the average winding loss of a disclosed embodiment winding structure can be 1.07 W, which is 0.18 W lower than the 1.25 W of the current approaches.

TABLE I
THE AVERAGE OF WINDING LOSS

| | |
|---|---|
| Winding | Core Structure |

| Structure | Traditional | Distributed Air-gap |
|---|---|---|
| Unimproved | 2.415 W | 1.25 W |
| Improved | 1.588 W | 1.07 W |

Compared to using current approaches, when using the example according to an embodiment of distributed air-gap core structure, the average winding loss of the unimproved winding structure was reduced by 1.165 W. This reduction can be attributed to the distributed air-gap structure's ability to decrease both stray and diffusion flux in the core. Furthermore, the example according to an embodiment winding structure reduces the winding loss by 0.518 W when using a distributed airgap structure and this reduction can be achieved as the by use of techniques disclosed herein to enable suppression the fringing field of the air gap. By subtracting 0.518 W from 1.165 W, it is found that the example according to an embodiment with distributed air gap core structure can suppress stray flux by 0.647 W. Thus, the example according to an embodiment with improved winding structure and distributed air-gap core structure can substantially reduce stray flux.

### EXAMPLES

Various examples of the present disclosure are provided below. As used below, any reference to a series of examples is to be understood as a reference to each of those examples disjunctively.

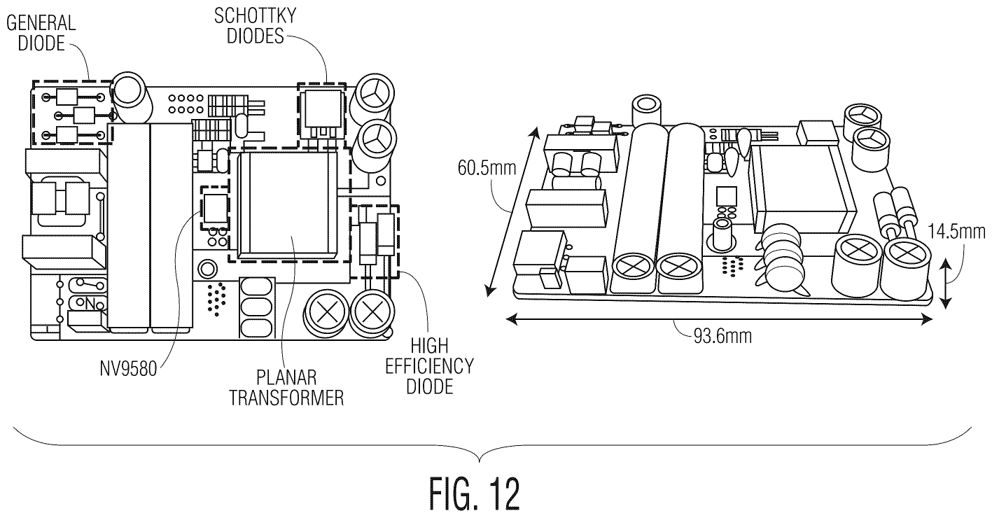

FIG. 12 shows a modification coupon having a prototype of a 78 W dual-output QR flyback converter for a television power supply. The modification coupon using embodiments of the disclosure for winding structure produced 1.2% increase in overall efficiency of the power converter and substantial decrease in the temperature of the planar transformer compared to winding structures used by current approaches. Due to the requirements of high stability and low cost in television power supplies, Schottky diodes and high-efficiency diodes were employed as the output diodes for 12V and 120V, respectively. Aluminum electrolytic capacitors were chosen as the output filtering capacitors. The prototype utilizes NV9580 as the main control switch for the QR flyback converter. The NV9580 integrates the analog controller and GaN switches into a compact QFN5x6 semiconductor package, thereby enabling the NV9580 to simplify the complexity of the control loop and allowing the QR flyback converter to operate efficiently at frequencies in the several hundred kHz range.

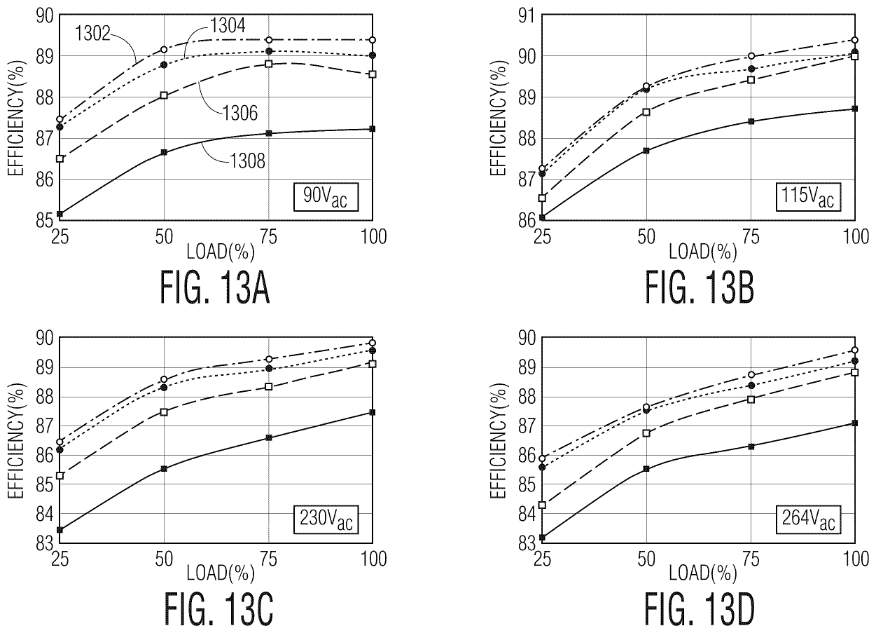

FIGS. 13A-13D shows graphs of efficiency as a function of load for various embodiments of disclosed planar transformer with low winding loss at various input voltage levels. Graph 1302 shows the results for disclosed planar transformer with improved winding structure with distributed air gap structure, graph 1304 shows the results for current approaches with distributed air gap structure, graph 1306 shows the results for disclosed planar transformer with improved winding structure without distributed air gap structure, and graph 1308 the results for current approaches without distributed air gap structure. FIG. 13A shows the results for an input volta of 90 Vac, FIG. 13B shows the results for an input voltage of 115 Vac, FIG. 13C shows the results for an input voltage of 230 Vac, and FIG. 13D shows the results for an input voltage of 264 Vac. The results show that when used with current approaches for core structure, the disclosed embodiments of winding structure produce 1.2% increase in overall efficiency of the power converter as compared to the current approaches. When the planar transformer uses a distributed air gap core structure according to an embodiment of the disclosure, it can increase the overall power converter efficiency 0.3% increase.

Moreover, thermal steady-state distribution for the examples of FIGS. 13A-13D show that the planar transformers according to embodiments of the disclosure can substantially reduce the thermal steady-state temperature of the power converter. For example, a reduction in temperature of 30-50° C. can be achieved as compared to current approaches. In various embodiments, a reduction in temperature of 27° C. can be achieved as compared to current approaches.

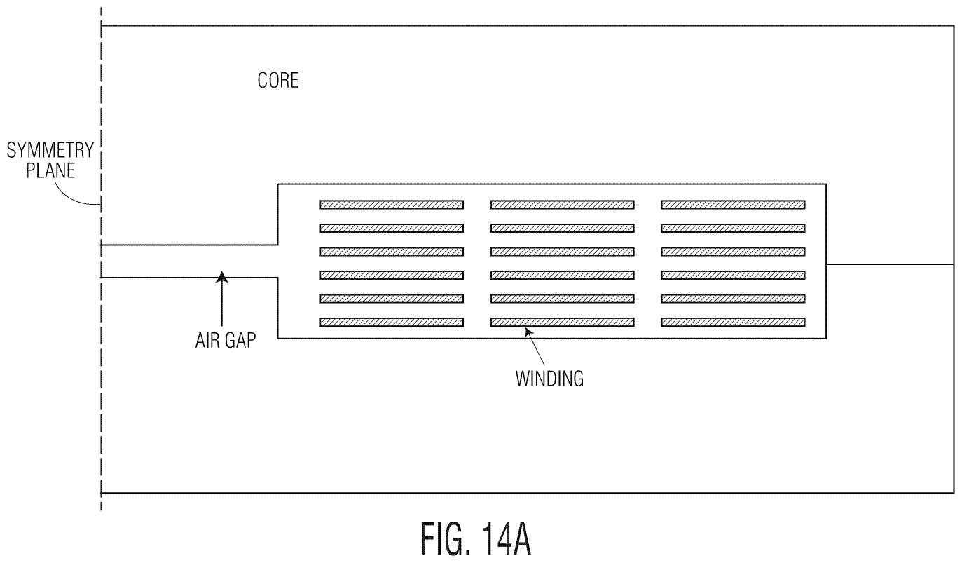

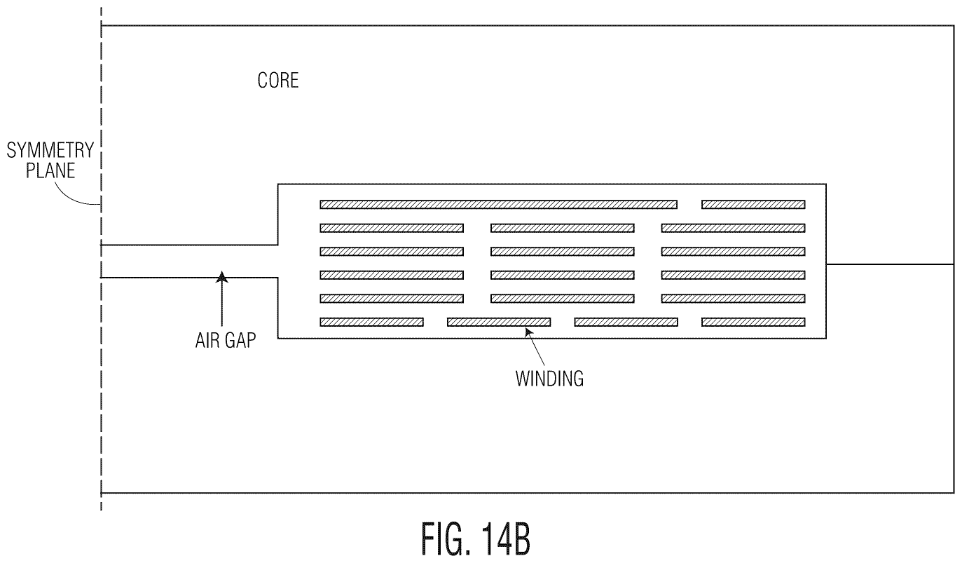

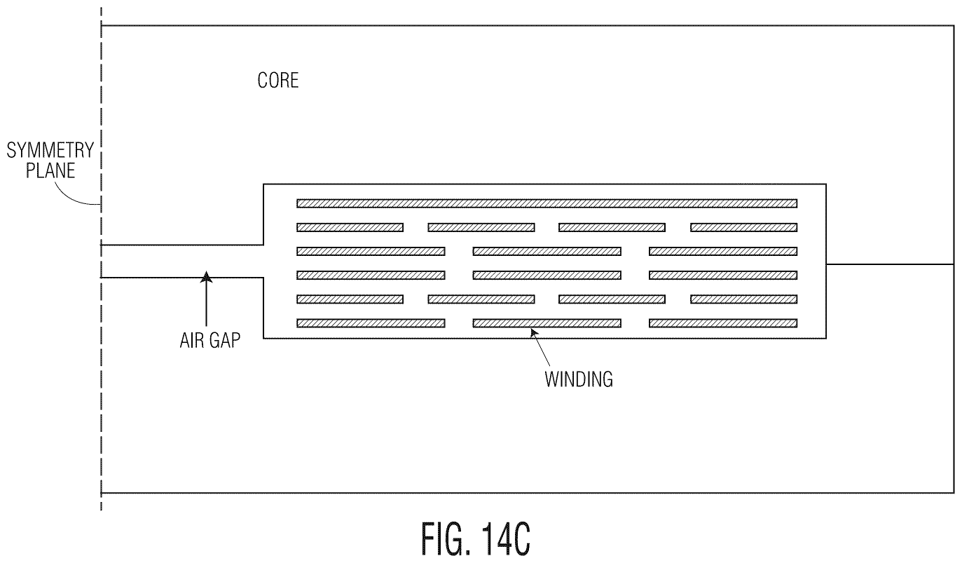

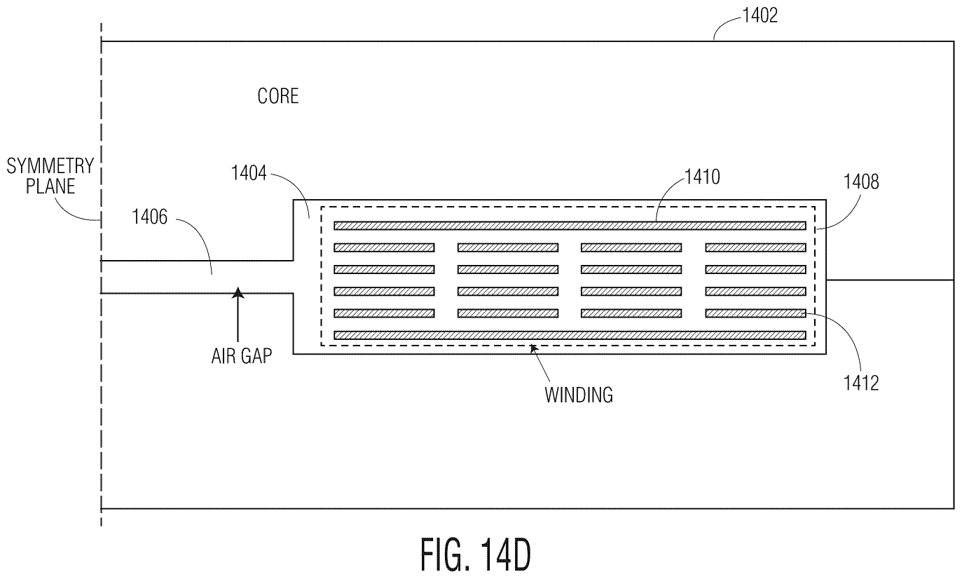

FIGS. 14A-14D illustrates cross-sectional views of inductors having windings with varied width, according to some embodiments. In the illustrated embodiments, an inductor may have windings with varied width where external windings extend across a substantial portion of the inductor area in order to block stray flux. In the illustrated embodiments, the planar transformer can include a 6-layer PCB-wound “EE” type planar inductor. The illustrated planar inductors may have similar parameters except for their winding structure. FIG. 14D illustrates a magnetic core 1402 that can have a central region 1404, and a conductor 1408 having a first winding 1410 extending around the central region 1404 and a second winding 1412 extending around the central region 1404. A first width of the conductor 1408 in the first winding may be greater than a second width of the conductor in the second winding. The magnetic core may further include an air gap 1406.

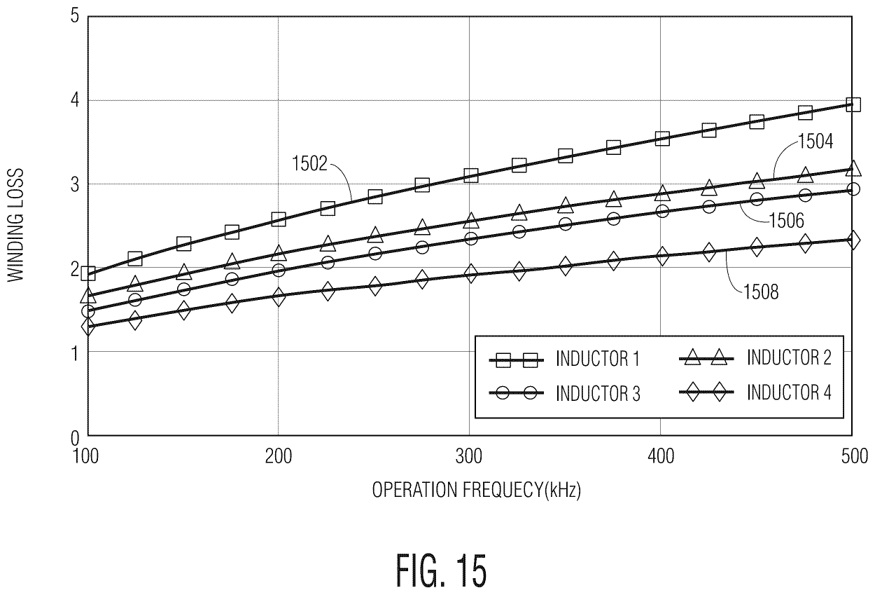

FIG. 15 illustrates graphs showing the winding losses for winding structures of FIGS. 14A-14D as a function of frequency. Graph 1502 shows winding loss as a function of frequency for structure in FIG. 14A. Graph 1504 shows winding loss as a function of frequency for structure in FIG. 14B. Graph 1506 shows winding loss as a function of frequency for structure in FIG. 14C. Graph 1508 shows winding loss as a function of frequency for structure in FIG. 14D. The stray flux suppression effect of the inductor structures of FIGS. 14A-14D results in a reduction in winding losses. In the case of the inductor structure of FIG. 14D, the winding losses decrease by more than 30% as compared to current approaches. Furthermore, as the operating frequency increases, the reduction in winding losses is increased.

Although structures and techniques disclosed are described and illustrated herein with respect to some particular configurations of a multi-output power converters, embodiments of the disclosure are suitable for use with other configurations of power converters. For example, multi-output converters are not limited to just two outputs, but also include three, four, or multi-outputs. Multi-output converters are not limited to just flyback converters, but also include, among others, ACF, AHB, and LLC converters.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

One of ordinary skill in the art will appreciate that other modifications to the apparatuses and methods of the present disclosure may be made for implementing various applications of the methods and systems for enhanced area getter architecture for a wafer-level vacuum packaged uncooled focal plane array without departing from the scope of the present disclosure.

The examples and embodiments described herein are for illustrative purposes only. Various modifications or changes in light thereof will be apparent to persons skilled in the art. These are to be included within the spirit and purview of this application, and the scope of the appended claims which follow.

What is claimed is:

1. A transformer comprising:
a magnetic core having a central region;
a primary winding extending around the central region;
a first secondary winding including a first conductor having one or more first turns extending around the central region, wherein the first conductor has a first width and is arranged to receive electromagnetic flux from the primary winding; and
a second secondary winding including a second conductor having one or more second turns extending around the central region, wherein the second conductor has a second width and is arranged to receive electromagnetic flux from the primary winding, wherein a number of the one or more second turns is greater than a number of the one or more first turns and the first width is greater than the second width.

2. The transformer of claim 1, wherein the magnetic core defines a winding region that is concentric with the central region and has a predefined width to receive the first and second secondary windings.

3. The transformer of claim 2, wherein the predefined width is greater than the second width of the second conductor.

4. The transformer of claim 2, wherein the second width is greater than 50% of the predefined width.

5. The transformer of claim 2, wherein the second width is greater than 75% of the predefined width.

6. The transformer of claim 2, wherein the second width is greater than 90% of the predefined width.

7. The transformer of claim 1, wherein the first secondary winding is on a first layer and the second secondary winding is on a second layer.

8. The transformer of claim 1, wherein the first secondary and at least a portion of the second secondary winding are on a same layer.

9. An inductor comprising:
a magnetic core having a central region; and
a conductor having a first winding extending around the central region and a second winding extending around the central region, wherein a first width of the conductor in the first winding is greater than a second width of the conductor in the second winding.

10. The inductor of claim 9, wherein the magnetic core has a predefined width to receive the first and second windings.

11. The inductor of claim 9, wherein the first winding is an exterior winding and the second winding is an interion winding.

12. The inductor of claim 9, wherein the conductor further comprises a third winding extending around the central region and having the first width.

13. The inductor of claim 9, wherein the second winding is position between the first and third winding.

14. The inductor of claim 9, wherein the magnetic core defines a winding region that is concentric with the central region and has a predefined width to receive the first and second windings.

15. The inductor of claim 10, wherein the first width is at least 75% of the predefined width.

16. The inductor of claim 10, wherein the first width is at least 90% of the predefined width.

17. A method of forming a transformer, the method comprising:
providing a magnetic core having a central region;
forming a primary winding extending around the central region;
forming a first secondary winding including a first conductor having one or more first turns extending around the central region, wherein the first conductor has a first width and is arranged to receive electromagnetic flux from the primary winding; and
forming a second secondary winding including a second conductor having one or more second turns extending around the central region, wherein the second conductor has a second width and is arranged to receive electromagnetic flux from the primary winding, wherein a number of the one or more second turns is greater than a number of the one or more first turns and the first width is greater than the second width.

18. The method of claim 17, wherein the magnetic core defines a winding region that is concentric with the central region and has a predefined width to receive the first and second secondary windings.

19. The method of claim 18, wherein the predefined width is greater than the second width of the second conductor.

20. The method of claim 18, wherein the second width is greater than 50% of the predefined width.
